(19) United States
(12) Patent Application Publication
(10) Pub. No.: US 2024/0143660 A1
(43) Pub. Date: May 2, 2024

(54) OFFLINE EVALUATION OF RANKED LISTS USING PARAMETRIC ESTIMATION OF PROPENSITIES

(71) Applicant: ADOBE INC., SAN JOSE, CA (US)

(72) Inventors: Vishwa Vinay, Indiranagar Bangalore (IN); Manoj Kilaru, Sunnyvale, CA (US); David Thomas Arbour, San Jose, CA (US)

(21) Appl. No.: 17/978,477

(22) Filed: Nov. 1, 2022

(51) Int. Cl. G06F 16/2457

(52) U.S. Cl. CPC G06F 16/24578

(57) ABSTRACT

In various examples, an offline evaluation system obtains log data from a recommendation system and trains an imitation ranker using the log data. The imitation ranker generates a first result including a set of scores associated with document and rank pairs based on a query. The offline evaluation system may then determine a rank distribution indicating propensities associated with the document and rank pairs for a set of impressions which can be used to determine a value associated with the performance of the new recommendation system.

Users are often attracted to specific visual and linguistic characteristics of digital content—such as search results, rankings, advertisements, videos, product reviews, and other digital media. However, because it can be difficult to determine what characteristics will provide optimal results for users, engineers must often guess as to what will improve the user experience. For example, when engineers design a new recommendation system or changes an existing recommendation system, the engineers often have very little information to use to predict the efficacy of the new or changed recommendation system.

In some conventional solutions, engineers experiment with multiple variations of content by randomly presenting different content to different users and tracking the outcome of each variation to make decisions on which content is optimal for the users (e.g., A/B testing). However, while these experiments typically provide engineers with certain performance insights for a variety of content, it is often very time consuming to collect data from these experiments, and the data provides very little insight into which specific characteristics of the content correlate with a positive or negative performance of the content.

### SUMMARY

In accordance with some aspects of the technology described herein, an offline evaluation system uses parametric estimates to determine propensities associated with ranked results generated by changes to a recommendation system to eliminate the biases of log data. For example, by utilizing an imitation ranker model and parametric estimates, a robust unbiased offline evaluation can be achieved when new rankings to be evaluated differ from the logged ones. As a result, the offline evaluation system effectively uses data collected by the recommendation system (e.g., log data) to mitigate the implementation costs of performing A/B tests and the risks of reduced user experience, while providing an unbiased estimate of the effect of the proposed changes obtained using biased historical data.

When changes are made to an existing recommendation system, the offline evaluation system measures a value of those changes (e.g., do the changes improve the user experience). In various embodiments, the offline evaluation system includes an imitation ranker model (e.g., support vector machine, gradient boosting machine, neural network, etc.) trained using log data obtained from the existing recommendation system. Furthermore, in such embodiments, the imitation ranker model and the new recommendation system (e.g., the existing recommendation system including the changes) each generate a ranked set of documents (e.g., a list of documents in a particular order) based on a query. In some aspects, the offline evaluation system determines a parametric estimation for the probability of a particular document being observed at a particular rank (e.g., document and rank pair) in response to the query. This propensity is used for unbiased estimation of a relevance metric for the changes to the existing recommendation system (e.g., a new ranking policy, a new ranker, modifications to various values, etc.).

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a block diagram illustrating an exemplary system in accordance with some implementations of the present disclosure;

FIG. 2 depicts a diagram of an offline evaluation system computing propensity in accordance with some implementations of the present disclosure;

FIG. 3 depicts a diagram of an offline evaluation system computing propensity in accordance with some implementations of the present disclosure;

FIG. 4 is a flow diagram showing a method for determining propensities of document and rank pairs in accordance with some implementations of the present disclosure;

FIG. 5 is a flow diagram showing a method for training an imitation ranker in accordance with some implementations of the present disclosure;

FIG. 6 is a flow diagram showing a method for determining the performance of a recommendation system in accordance with some implementations of the present disclosure; and

FIG. 7 is a block diagram of an exemplary computing environment suitable for use in implementations of the present disclosure.

### DETAILED DESCRIPTION

### Definitions

Various terms are used throughout this description. Definitions of some terms are included below to provide a clearer understanding of the ideas disclosed herein.

As used herein, a “recommendation system” refers to a system including at least one ranker that returns results to queries. In accordance with some aspects of the technology described herein, a “new recommendation system” includes a new ranker in place of a current ranker of the recommendation system.

As used herein, an “offline evaluation system” refers to a system that determines the performance of a new ranker. In accordance with some aspects of the technology described herein, an offline evaluation system uses parametric propensities to measure the performance of a new ranker that is not biased by log data (e.g., historical performance) of a current ranker, as described in further detail below.

A “current ranker” is a component of a recommendation system in accordance with some aspects of the technology described herein that returns a ranked set of documents in response to a query. In some configurations, the current ranker includes one or more models, as described in further detail below.

A “new ranker” is a component of a recommendation system in accordance with some aspects of the technology described herein that returns a ranked set of documents in response to a query. In some configurations, the new ranker includes one or more changes to the current ranker, as described in further detail below.

An “imitation ranker” is a component of an offline evaluation system in accordance with some aspects of the technology described herein that simulates a current ranker returning a ranked set of documents in response to a query. In some configurations, the imitation ranker is a model trained using log data collected from a current ranker, as described in further detail below.

The term “document” refers to an item included in a result returned to a user in response to a query. A document comprises any data or reference to data included in a list of results.

The term “ranked set of documents” refers to an ordered set of documents included in a result returned in response to a query. A ranked set of documents includes documents in an order determined by a ranker indicating a relevance to a query.

The term “impression” refers to a ranking of documents over a subset of documents obtained from a set of documents. In some aspects, an impression includes a subset of a larger ranked set of documents.

The term “value” refers to a result of a computing an estimate or otherwise measuring the performance of a ranker. A value includes a metric or other score computed as a method for evaluating the performance of a ranker.

### Overview

Embodiments described herein generally relate to offline evaluation of a new recommendation system that uses a new ranker in place of a current ranker of a recommendation system. In accordance with some aspects, an offline evaluation system computes a rank distribution given a set of impressions (e.g., document and rank pairs that match between an imitation ranker and the new recommendation system) to determine a propensity associated with each document and rank pair, which is used by the offline evaluation system to evaluate the performance of the new recommendation system.

Many user-facing applications display a ranked list of documents such as search results, advertisements, recommendations, or other information to users. The design of such an application involves many choices, and the effect of each choice needs to be evaluated to determine the effect of each choice on the user experience. Designers and/or engineers of search engines, recommendation systems, and/or ranking systems may attempt to improve the quality of the user experience these systems provide by modifying the choices. For example, by refining a ranker that produces a list of results displayed in response to user queries, the user experience of the ranker is improved and the user is provided with improved results.

One approach to improve quality and/or user experience of recommendation systems includes service providers making to changes to existing rankers of the recommendation systems (e.g. new ranking features, different ranking models, modified user interface, new rankers, additional rankers, etc.) and performing A/B tests using a subset of the user base to establish a value associated with the change. However, A/B testing may degrade the user experience, thereby negatively impacting the subset of users that were exposed to the change. In addition, A/B testing can be unnecessarily costly and time consuming.

Another approach includes estimating the effectiveness of the changes to an existing ranker of the recommendation system by predicting what the user behavior would have been on results generated by changes to the existing ranker of the recommendation system (e.g., a new ranker) based on previously collected data (e.g., log data). However, this approach includes biases inherent in the log data (e.g., the value of the change may be skewed by the existing recommendation system). For example, the previously collected data is biased by only having user interactions on documents presented at the previously decided rank positions and a new ranker might differ from the previous ranker in terms of the set of results shown and their corresponding ordering. Moreover, the previously collected data may reflect users' inherent biases, like preferring results at higher ranks.

In some conventional solutions for evaluating rankers and/or recommendation systems, service providers (e.g., the entities providing recommendation systems) experiment with multiple variations of content by randomly presenting different content to different users. For example, a service provider could experiment with two or more rankers by randomly displaying the results to users (e.g., AB testing). Then, the service provider could track user engagement with the two or more rankers. Using the outcome of this experiment, the service provider might make decisions on which of the rankers best engages the users. However, while these experiments typically provide certain performance insights for a variety of content, it is often very time consuming to collect data from these experiments and the data provides very little insight into which specific characteristics of the content correlate with a positive or negative performance of the content.

Aspects of the technology described herein improve the functioning of the computer itself in light of these shortcomings in existing technologies by providing an offline evaluation system that employs an imitation ranker to facilitate evaluation a new recommendation system with a new ranker and/or changes to an existing rankers. The imitation ranker is trained using log data collected from an existing recommendation system (e.g., results produced by a ranker). For example, the imitation ranker is trained to approximate logged rankings (e.g., ranked sets of documents returned by the recommendation system in response to queries) using knowledge distillation. As such, the imitation ranker can increase the amount of data available to the offline evaluation system to evaluate changes to the recommendation system and/or ranker. Furthermore, in various embodiments, the imitation ranker generates a score and/or probability of a particular document being in a particular rank (e.g., a pairwise probability). In addition, in some embodiments, the scores generated by the imitation ranker are tuned or otherwise modified using one or more hyperparameters. For example, the one or more hyperparameters represent the uncertainty in the score provided by the imitation ranker.

In various embodiments, a rank distribution per document is computed based on results from the imitation ranker and the new recommendation system for a particular query. In one example, a recursive algorithm is used to compare documents in the results from the imitation ranker and the new ranker of the recommendation system. By evaluating documents at particular ranks that match between the imitation ranker and the new ranker, as opposed to evaluating the list of documents as a whole, the amount of data available to the offline evaluation system is increased. For example, if a query response includes 20 documents, there could be only a small number of queries that cause the imitation ranker and the new recommendation system to generate identical lists of documents.

Furthermore, in an embodiment, the rank distribution computed by the offline evaluation system includes document and rank propensities (e.g., the probability of a document at a given rank) which can be used in Inverse Propensity Weighting (IPW) mechanisms to generate a value associated with the new ranker of the recommendation system. For example, the offline evaluation system provides a parametric estimation for the probability of a document being observed at a certain rank in response to a given query and this propensity can be used for unbiased estimation of the value (e.g., relevance metric) for the new ranker of the recommendation system.

Advantageously, the offline evaluation system described herein provides for evaluating changes to an existing ranker of the recommendation system that eliminates biases from the log data collected from the current ranker of the recommendation system. In addition, the offline evaluation system can eliminate the need for costly and time-consuming AB testing. For example, the offline evaluation system can provide a metric and/or other value that indicates whether changes to the current ranker (e.g., changes to generate a new ranker of the recommendation system) provide a benefit or otherwise improve the user experience. Furthermore, the offline evaluation system can provide an indication as to whether additional testing would be beneficial. For example, if the offline evaluation system indicates that a particular change to the recommendation system is an improvement, AB testing can be performed to determine an extent of the improvement. As a result, the offline evaluation system provides an efficient unbiased method for evaluating changes and/or new recommendation systems.

### Example System for Offline Evaluation

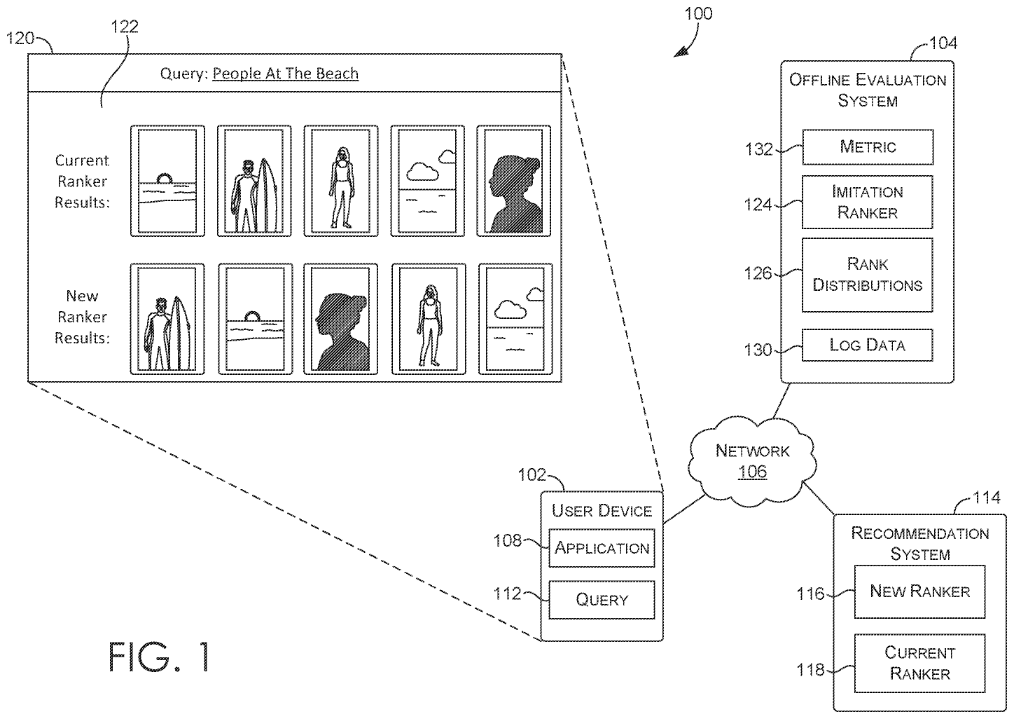

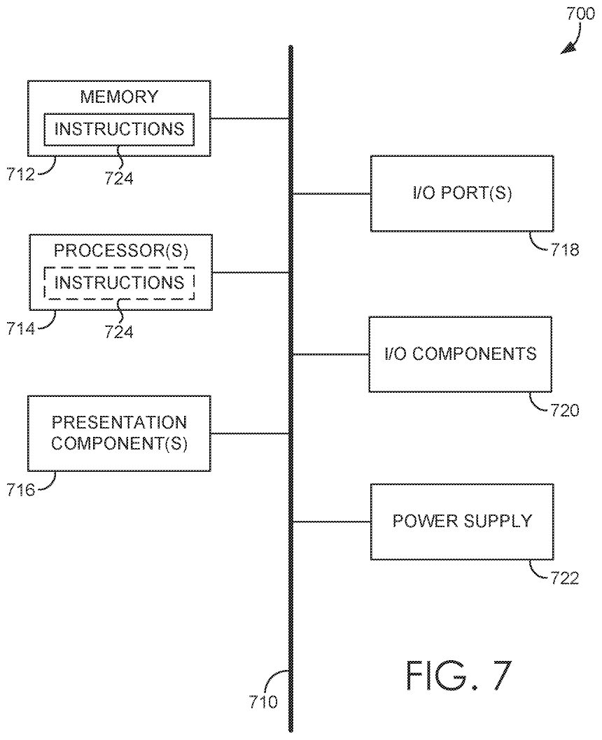

Turning to FIG. 1, FIG. 1 is a block diagram illustrating an exemplary system 100 for performing offline evaluation of a recommendation system 114 in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory as further described with reference to FIG. 7.

It should be understood that the exemplary system 100 shown in FIG. 1 is an example of one suitable operating environment. Among other components not shown, exemplary system 100 includes a user device 102, an offline evaluation system 104, a recommendation system 114, and a network 106. Each of the components shown in FIG. 1 can be implemented via any type of computing device, such as one or more computing devices 700 described in connection with FIG. 7, for example. These components can communicate with each other via network 106, which can be wired, wireless, or both. Network 106 can include multiple networks, or a network of networks, but is shown in simple form so as not to obscure aspects of the present disclosure. By way of example, network 106 can include one or more wide area networks (WANs), one or more local area networks (LANs), one or more public networks such as the Internet, and/or one or more private networks. Where network 106 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 106 is not described in significant detail.

It should be understood that any number of devices, servers, and other components can be employed within the exemplary system 100 within the scope of the present disclosure. Each can comprise a single device or multiple devices cooperating in a distributed environment.

User device 102 can be any type of computing device capable of being operated by an entity (e.g., individual or organization) associated with an application 108 and a query 112 submitted to a recommendation system. The user device 102, in various embodiments, has access to or is otherwise capable of submitting queries 112 to the recommendation system 114 and obtaining results 122 of the queries 112 through the application 108. For example, the user device 102 includes a mobile device submitting the query 112 to a search engine provided by the recommendation system 114.

In some implementations, user device 102 is the type of computing device described in connection with FIG. 7. By way of example and not limitation, a user device 102 can be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 102 can include one or more processors, and one or more computer-readable media. The computer-readable media can include computer-readable instructions executable by the one or more processors. The instructions can be embodied by one or more applications, such as application 108 shown in FIG. 1. Application 108 is referred to as a single application for simplicity, but its functionality can be embodied by one or more applications in practice.

The application(s) 108 can generally be any application capable of facilitating the exchange of information between the user device 102 and the offline evaluation system 104 in executing queries 112. For example, the application 108 can include a web browser that connects to the recommendation system 114 to allow the user to submit the query 112. In some implementations, the application 108 comprises a web application, which can run in a web browser, and can be hosted at least partially on the server-side of the exemplary system 100 (e.g., recommendation system 114 or other server computer systems that provide services to the user device 102). In addition, or instead, the application 108 can comprise a dedicated application, such as an application being supported by the user device 102 and the recommendation system 114. In some cases, the application 108 is integrated into the operating system (e.g., as a service). It is therefore contemplated herein that “application” be interpreted broadly. Some example applications include ADOBE® SIGN, a cloud-based e-signature service, and ADOBE ACROBAT®, which allows users to view, create, manipulate, print, and manage documents.

In accordance with embodiments herein, the application 108 facilitates the generation of log data 130 by at least submitting queries 112 and obtaining results 122 from the recommendation system 114. For example, user device 102 can submit the query 112 to the recommendation system 114 and a current ranker 118 generates a response to the query (e.g., a ranked list of results 122) which is provided to the user device 102. Although, in some embodiments, a user device 102 provides the query 112, embodiments described herein are not limited hereto. For example, in some cases, the recommendation system 114 obtains queries 112 from a plurality of users and generates the log data 130 or otherwise maintains information associated with the queries 112 and results 122. In yet other embodiments, another service and/or application generates the log data 130 and provides the log data 130 to the offline evaluation system 104.

The recommendation system 114 is generally configured to evaluate queries 112 and return results 122. For example, the recommendation system includes a search engine, advertisement engine, catalog, database, or other user-facing application that provides or otherwise displays ranked lists of documents such as images, items, Uniform Resource Locators (URLs), metadata, advertisements, titles, or other information. The recommendation system 114, in an embodiment, includes a current ranker 118 and a new ranker 116. The current ranker 118 and the new ranker 116, for example, include an application, algorithm, policy, heuristic, model, neural network, machine learning algorithm, network, or other logic embodied in source code or other executable code that, as a result of being executed by one or more processors, cause the one or more processors to execute the query 112 by at least searching a corpus of documents or other collection of items to generate a ranked set of documents.

Furthermore, in an embodiment, the current ranker 118 is in production or otherwise accessible to the user device 102 and the new ranker 116 includes one or more changes to the current ranker 118. For example, as described above, the current ranker 118 is refined or otherwise modified to generate the new ranker 116 and improve a user experience 120. In various embodiments, the new ranker 116 includes new ranking features, different ranking models, modifications to one or more parameters of the current ranker 118, or other changes that alter the user experience 120 and/or results 122.

The offline evaluation system 104 is generally configured to generate a metric 132 to determine or otherwise measure the performance of the new ranker 116. For example, as illustrated in FIG. 1, the offline evaluation system 104 utilizes the log data 130 to train an imitation ranker 124 and then determines rank distributions 126. At a high level, the rank distributions 126 indicate a propensity which represents how likely the current ranker 118 is to return the result 122 to the query 112 which enables the offline evaluation system 104 to re-weight the data to simulate the situation where the log data 130 was collected using the new ranker 116. For example, where the log data 130 is a dataset collected by an operational search engine (e.g., the current ranker 118) which follows a policy π for retrieving and ranking documents in response to the query 112 and user interactions with the documents (e.g., user clicks, mouse activity, eye tracking, or other data that indicates user engagement with a particular document at a particular rank) are used as a feedback signal, the log data can be defined by the following equation:

D_{π}=(q, I, c). (1)

In the equation (1) above, D_{π} represents the log data 130 (e.g., the dataset used to train the imitation ranker 124) collected from the current ranker 118 where q represents the user query, I is an ordered list of documents returned in response to q, and c is an array where element cₖ∈{0, 1} indicates if the document at rank k was interacted with by the user (e.g., clicked). As described herein, the ordered list I is defined as an impression, referred to as π(q), which includes a ranking over a small set of K documents obtained from a large set of indexed items where Iₖ=d provides the identifier of the document that was shown at rank k in the results 122. In an embodiment, the log data 130 (e.g., D_{π}) contains the same query (e.g., query 112) multiple times, and the impressions (e.g., results 122) across the occurrences of the query 112 can have variations. For example, if the current ranker 118 is stochastic and/or deterministic, the current ranker 118 includes a feedback loop or other context-aware features which can alter the ranking in response to user behavior and/or user interaction.

When determining the metric 132 associated with the new ranker 116, in an embodiment, the offline evaluation system 104 obtains results generated by the new ranker 116 in response to the query 112 represented by Ī=μ(q) where: μ is the new ranker 116, q is the query 112, and Ī is the impression. For example, each Ī is evaluated with respect to the metric 130 defined as M(Ī, c) for a given impression Ī and user interaction (e.g., click) c which can be decomposed in an additive manner over individual documents using the following equation:

M(I, c)=Σₖ₌₁^{K}m(cₖ, k). (2)

In some aspects of equation (2), the relevance of an impression is an aggregation of user interactions observed on documents. Furthermore, in various embodiments, different metrics can be used in connection with equation (2), such as number of clicks (NoC): NoC(I, c)=Σₖ₌₁^{K}cₖ or Mean Reciprocal Rank (MRR):

$$M R R ( I , c ) = \frac{1}{K} {\sum }_{k = 1}^{K} \frac{{c}_{k}}{k} .$$

Although NoC and MRR are used as examples above, other metrics such as Kendall tau, expected reciprocal rank, mean average precision, precision at k, and/or normalize discounted cumulative gain (e.g., log(k) as opposed to k) can be used in accordance with various embodiments described herein.

In embodiments where the current ranker 118 and the new ranker 116 generate different results 122, there can be documents without data indicating user interaction. Furthermore, in such embodiments, when evaluating the new ranker 116, considering only results where the current ranker 118 and the new ranker 116 provide the same results 112 produces metrics 130 that are biased by the current ranker 118 and/or log data 130. In order to eliminate this bias, in various embodiments, the offline evaluation system 104 uses an Inverse Propensity Weighting (IPW) mechanism defined by the following equation:

$${\hat{V}}_{L} ( μ ) = \frac{1}{\vert {D}_{π} \vert} {\sum }_{( q , I , c ) ∈ {D}_{π}} \frac{1 \{ \overline{I} = I \}}{\hat{p} ( \overline{I} \vert q )} {\sum }_{k = 1}^{K} m ( {c}_{k} , k ) \qquad ( 3 )$$

In equation (3) above, propensity refers to the term \hat{p}(Ī|q), which represents how likely it is that the current ranker 118 (e.g., π) returned impression I in response to query 112 (e.g., q). In various embodiments, the propensity is to re-weight the values so as to simulate the situation where the log data 130 (e.g., D_{π}) was collected in an experimental setting (e.g., using the new ranker 116). Furthermore, in equation (3) the subscript L in \hat{V}_{L}, indicates that the propensity is computed at a list level (e.g., the entire ranked set of documents included in the result 122). However, this approach can be statistically inefficient—a significant fraction of log data 130 (e.g., D_{π}) will be discarded if only exact matches at the list level are used.

In order to improve utilization of the logged data 130, in various embodiments, offline evaluation system 104 utilizes document-level matches. For example, a (document, rank) combination—R(d, k|q)—is modeled jointly and used to determine the metric 132. In an embodiment, a Position-Based Model is obtained by setting R(d, k|q)=R(d|q)*E(k), which includes a relevance-only component and a per-rank examination factor. In embodiments where the document and rank pair is used (e.g., R(d, k|q)), equation (3) above can be modified as:

$${\hat{V}}_{IP} ( μ ) = \frac{1}{\vert {D}_{π} \vert} {\sum }_{( q , I , c ) ∈ {D}_{π}} {\sum }_{k = 1}^{K} \frac{1 {\overline{I}}_{k} = {I}_{k}}{\hat{p} ( {\overline{I}}_{K} , k \vert q )} m ( {c}_{k} , k ) . \qquad ( 4 )$$

In equation (4) above, the matching operates at the level of individual documents, where D_{π} indicates the probability of a particular impression given the current ranker 118 (e.g., based on the log data). In addition, in equation (4), Īₖ=Iₖ indicates that the new ranker 116 and the imitation ranker 124 produce the same impression based on query 112 (e.g., q). For example, when the new ranker 116 (e.g., μ) places a document d at rank k for query 112 (e.g., q), a historical impression (e.g., obtained from the log data 130) that contains this {d, k, q} tuple contributes to the estimated value (even if there are differences in documents at other ranks). In various embodiments, the corresponding propensity (e.g., \hat{p}(Īₖ, k|q)) is used to re-weight the log data 130 to account for the non-uniform likelihood of the current ranker 118 (e.g., π) placing particular documents items at particular ranks. For example, since the term \hat{p}(Īₖ, k|q) includes the document (Īₖ=d) and the rank (k), this indicates a (document, rank) propensity.

In various embodiments, equation (4) above increases the amount of data available to determine the metric 132 by at least evaluating the new ranker 116 results 122 that include at least one match between a particular document that has the same rank in both ranked sets of documents (e.g., from the current ranker 118 and the new ranker 116). For example, the value \hat{V}_{IP}(μ) indicates whether the new ranker 116 provides an improvement relative to the current ranker 118. Furthermore, as mentioned above, the term \hat{p}(Ī_{K}, k|q) eliminates the bias inherent in the log data 130 by at least summing over all the instances where the new ranker 116 and the imitation ranker 124 produce the same result (e.g., same document in the same rank) and de-biases the log data 130. In addition, the term m(cₖ, k) in equation (4) indicates the outcome that is measured in the log data 130 (e.g., user interactions).

In various embodiments, empirical propensities are computed using the following equation:

$$\hat{p} ( d , k \vert q ) = \frac{{\sum }_{( {q}^{′} , I , c ) ∈ {D}_{π}} 1 ( {I}_{k} = d ) 1 \{ {q}^{′} = q \}}{{\sum }_{( {q}^{′} , I , c ) ∈ {D}_{π}} 1 \{ {q}^{′} = q \}} . \qquad ( 5 )$$

For example, equation (5) estimates the propensity as the fractional number of times a particular document d was shown at rank k across all impressions for the query 112 (e.g., q) in the log data 130 (e.g., D_{π}). However, in some embodiments, the set of propensities obtained from equation (5) can be very sparse. For example, a particular tuple {d, k, q} that that only has a few occurrences in the log data 130 (e.g., D_{π}) will lead to a large inverse propensity weight when used in equation (4), and if the results from the new ranker 116 matches this tuple, the estimated \hat{V}_{IP}(μ) will have a large value. Therefore, in various embodiments, the imitation ranker 124 is trained using the log data 130 to simulate the current ranker 118. For example, the imitation ranker 124 is trained on the log data 130 (e.g., D_{π}) and a set of features for query-document pairs (e.g., (x_{qd})) to generate scores (e.g., (s_{sd}=f(x_{qd}))) that re-create impressions produced by current ranker 118. In such examples, given the set of K scores for an impression from a trained imitation ranker 124, a K×K matrix is generated by the rank distribution 126, where the entry at (d, k) provides the propensity for document d being placed at rank k.

In an embodiment, various different models, machine learning algorithms, neural networks, or other algorithms can be used to generate the imitation ranker 124. In one example, the imitation ranker 124 includes function f that produces a score (s_{qd}=f(x_{qd})) given the features of the query-document pair as input (e.g., the log data 130). Furthermore, in such an example, the features can include hand-crafted features or latent features from deep learning models. In one embodiment, a minimization of the RankNet algorithm is used to train the imitation ranker 124 using the following equation:

$${ℒ}_{pairwise} = {\sum }_{q ∈ Q} {\sum }_{( d , 𝓏 ) ∈ I : d ⊳ 𝓏} log ( 1 + exp ( {s}_{qd} - {s}_{q 𝓏} ) ) \qquad ( 6 )$$

where the set Q contains all the queries in the log data 130 and the document pairs (d, z) are chosen from the impression I such that d was ranked higher than z by the current ranker 118. As a result, in such embodiments, the imitation ranker 124 produces scores (e.g., probability of a particular document being at a particular rank) that represent the log data 130. In other embodiments, the imitation ranker 124 can be trained using knowledge distillation and/or weak supervision.

In various embodiments, the offline evaluation system 104 obtains results 122 to the query 112 from the imitation ranker 124 and the new ranker 116 and determines the rank distribution 126. For example, as described above, for a score s_{qd} of the document d for the query 112 (e.g., q) produced by the imitation ranker 112, an impression (e.g., from the log data 130) with K items leads to an array of K scores. In such examples, a Gaussianity assumption for the scores p(s_{qd})=N(S_{qd}; s_{qd}, σ²) is used and a pairwise contest probability p_{dz}, of document d being ranked higher than z is defined such that the log-likelihood of the log data (e.g., D_{π}) over the scores (e.g., rankings) produced by imitation ranker 124 is defined as:

$$\begin{matrix}{ℒ}_{σ} = {\sum }_{q ∈ Q} {\sum }_{( d , 𝓏 ) : d ⊳ 𝓏} log ( {p}_{d 𝓏} ) = {\sum }_{q ∈ Q} {\sum }_{( d , 𝓏 ) : d ⊳ 𝓏} log ( p ( {s}_{q d} - {s}_{q 𝓏} > 0 ) ) \\ = {\sum }_{q ∈ Q} {\sum }_{( d , 𝓏 ) : d ⊳ 𝓏} log ( {\int }_{0}^{∞} 𝒩 ( s : {s}_{q d} - {s}_{q 𝓏} , 2 {σ}^{2} ) ds )\end{matrix} \qquad ( 7 )$$

Equation (7) above evaluates the impression and examines, for any rank in the ranked set of documents, what is the probability of a particular document being ranked above or below (e.g., pairwise probability). For example, in equation (7), the imitation ranker 124 provides log p_{dz}, which is the probability of a document probability at a specific rank (e.g., document d at rank z). In addition, the quantity σ, in various embodiments, includes a hyperparameter that represents uncertainty in the value of the score produced by the imitation ranker 124. For example, if [symbol] _{σ} is a function of only σ (e.g., the document scores are given by imitation ranker 124), the value that corresponds to the maximal value of the log-likelihood in Equation (7) can be inferred. In another example, if scores produced by the imitation ranker 124 reflect the log data 130 accurately, a smaller value of σ will suffice.

In an embodiment, the rank distributions 126 generate a K×K matrix where W∈ [symbol] ^{K×K}, both the rows and the columns are associated with documents, and each element W_{dz} is set to p_{dz}. From this matrix, the rank distributions 126, in an embodiment, utilize a recursion mechanism to derive the matrix W̅∈ [symbol] ^{K×K} where the rows are associated with documents while the columns are associated with ranks. For example, the matrix is initialized by setting W̅_{dk}⁽¹⁾=δ(k):∀1≤d≤K where δ(x)=1 when x=1 and zero otherwise and for 1≤k≤K and 2≤t≤K, the matrix is recursively updated by considering each z≠d in turn as follows:

W̅_{dk}^{(t)}=P_{dz}W̅_{d,k-1}^{(t-1)}+(1−P_{dz})W̅_{dk}^{(t-)} (8)

In equation (8), the document d is referred to as the anchor and all other items z are compared to the document d. In an embodiment, once the recursion is complete, the rows and columns are normalized such that the K×K matrix is doubly stochastic (e.g., the entries for a given row (associated with documents) provide a distribution over ranks while traversing a column (rank) is a distribution over items). Furthermore in such embodiments, the resulting value of W̅_{dk}^{(t)} is used as the propensity \hat{p}(Iₖ, k|q) in equation (4), where d is the item indexed by Iₖ.

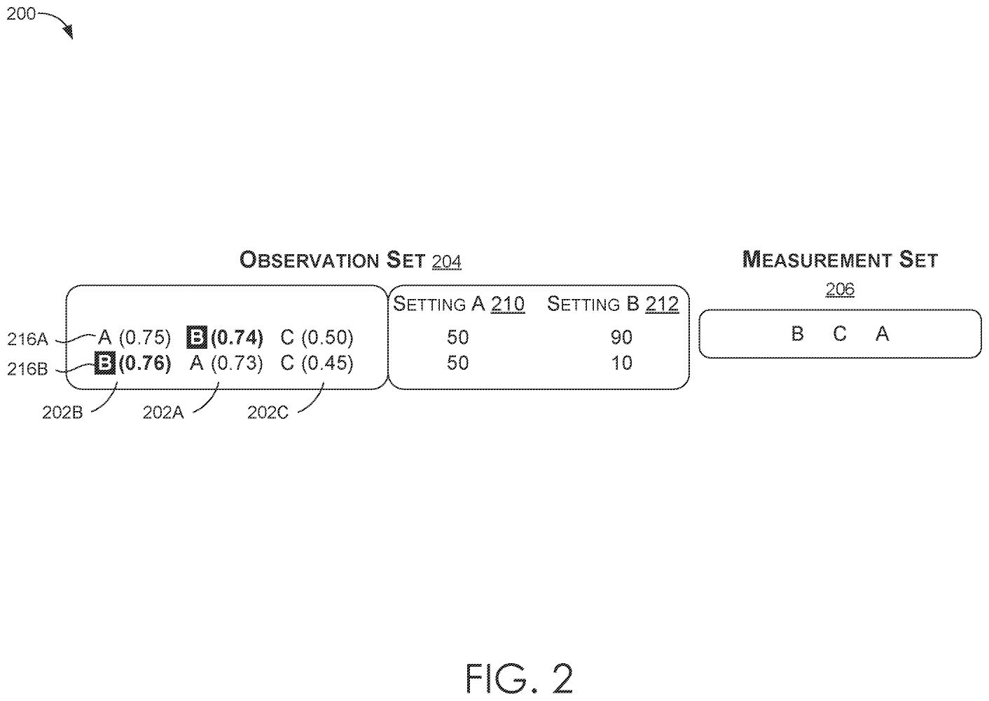

As described in greater detail below in connection with FIG. 2, equation (8) enables the rank distributions 126 to recursively compare a particular document at a particular rank relative to other documents in a particular impression. Furthermore, although the metric 132, imitation ranker 124, rank distributions 126 and log data 130, as illustrated in FIG. 1, are provided by the offline evaluation system, in various embodiments, all or a portion of these are provided by other entities such as a cloud service provider, a server computer system, and/or the recommendation system 114.

For cloud-based implementations, the application 108 is utilized to interface with the functionality implemented by the offline evaluation system 104. In some cases, the components, or portions thereof, of offline evaluation system 104 are implemented on the user device 102 or other systems or devices. Thus, it should be appreciated that the offline evaluation system 104 can be provided via multiple devices arranged in a distributed environment that collectively provide the functionality described herein. Additionally, other components not shown can also be included within the distributed environment.

FIG. 2 is an example 200 of the offline evaluation system computing the rank distributions in accordance with at least one embodiment. In the example 200 illustrated in FIG. 2, the rank distributions are determined given a query q and three documents A, B, and C, where the observation set 204 includes two impression 216A and 216B for the query q. For example, parametric estimates of the propensities are calculated taking advantage of similarities of documents in the feature space. Furthermore as illustrated in FIG. 2, for setting A 210, each of [A, B, C] and [B, A, C] were observed fifty times and for setting B 212, each of [A, B, C] was observed ninety times and [B, A, C] was observed ten times. In addition, in various embodiments, the measurement set 206 contains the impression [B, C, A]. As indicated by the shaded box around B, the document B is interacted with by the user in the example illustrated in FIG. 2. For example, the user clicked on document B.

In an embodiment, an imitation ranker generates a set of scores 202A (e.g., s_{qA}=0.73), 202B (e.g., s_{qB}=0.76), and 202C (e.g., s_{qC}=0.45). In such embodiments, when computing the rank distribution for document d=B as the anchor, an array W̅⁽¹⁾(B, ⋅)=[1, 0, 0] is generated, where each of the three entries indicates that B should be placed at the corresponding rank (e.g., first rank). For example, in a first iteration of the recursion, as described above in connection with equation (8), t=2, the rank distribution for d=B is updated by comparing it with z=A. Continuing with the example, for B to maintain the current rank (e.g., first rank), W̅⁽²⁾(B, 1)−1*p_{BA} must be higher than document A (e.g., the probability of being at rank 1 from the earlier iteration multiplied by the probability that document B is to be ranked higher than document A).

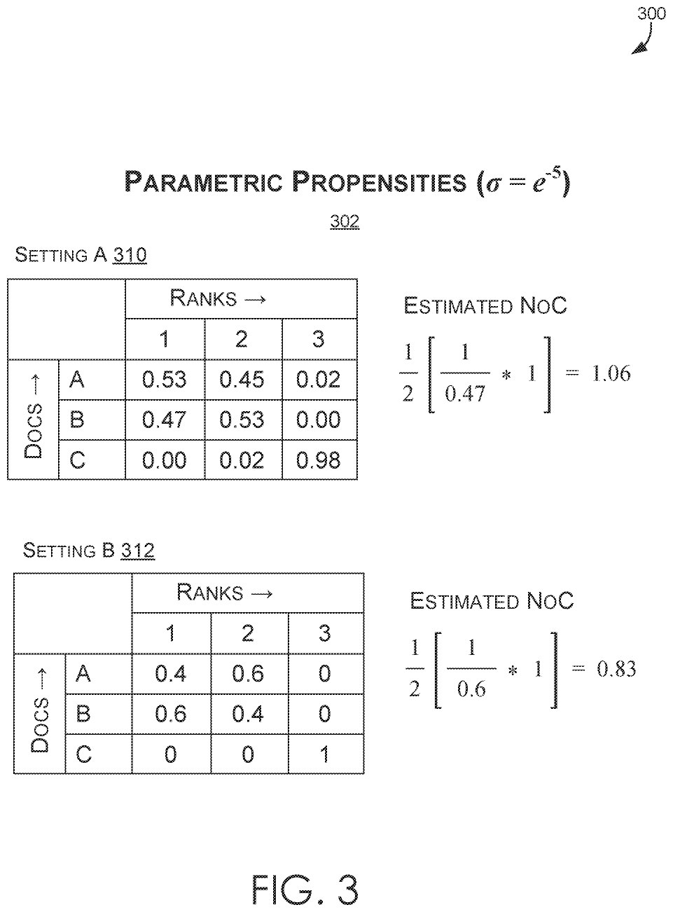

In an embodiment, the pairwise contest probability is given by p_{BA}=∫₀^{∞N(s; s}_{zB}−s_{zA}, 2σ²)ds as defined above. Furthermore, in an example, setting the hyperparameter σ=e⁻⁵ causes p_{BA}=0.602 as illustrated in FIG. 3. For example, if x_{qA}≈X_{qB}, then the hyperparameter σ should reflect this. Returning to the example above, with probability (1−p_{BA})=p_{BA}, document B loses the pairwise contest and drops to the second rank, which yields the updated rank distribution W̅⁽²⁾(B, ⋅)=[0.602, 0.398, 0]. Continuing the example, in the next iteration of the recursion, document B is compared against z=C, since, as defined above, the scores s_{qB}≈s_{qA}≈s_{qC}, and given the low standard deviation σ of the scores, the pairwise contest probabilities p_{AC}≈p_{BC}≈1. Thus, the final rank distribution of document B remains similar to above, e.g., [0.602, 0.398, 0], in the example. Therefore, in this example, the propensity of B being at rank 1 is \hat{p}(B, 1|q)≃0.6, as shown in FIG. 3.

FIG. 3 is an example 300 of the offline evaluation system computing parametric propensities 302 in accordance with at least one embodiment. For example, the parametric propensities 302 for the example 200 described above in connection with FIG. 2 are computed using equations (7) and (8). In addition, a metric is computed using the estimated NoC illustrated in FIG. 3, where the denominator two represents the number of impressions in the observation set (e.g., the observation set 204 described above contains two impressions).

For setting A 310, as illustrated in FIG. 3, the propensity of document B being at the first rank is 0.47 and for setting B 312, the propensity of document B beating at the first rank is 0.6. In an embodiment, the parametric propensities 302 are obtained by combining the scores with the inferred hyperparameter to compute the rank distribution per document using the recursive algorithm defined in equation (7). Furthermore, in such embodiments, the rank distribution (e.g., the document and rank propensities illustrated in FIG. 3 and computed using equation (8)) are then used in equation (4) to determine a value associated with a new ranker for every impression produced by the new ranker that is being evaluated. In an embodiment, training the imitation ranker and determining the optimal hyperparameter is performed once for a given set of log data and the result is used to evaluate a plurality of new rankers. For example, a new ranker can be evaluated using a trained imitation ranker (e.g., trained using the log data 130 described above), and, based on the results, the new ranker can be further modified and re-evaluated using the trained imitation ranker. In an embodiment, the offline evaluation system described herein can be used as a replacement and/or in addition to A/B testing. In one example, the offline evaluation system generates a metric for a new ranker, and if the metric meets a threshold value, A/B testing is performed using the new ranker. In another example, the offline evaluation system generates a metric for a new ranker in parallel to A/B testing of the new ranker.

### Example Methods for Offline Evaluation

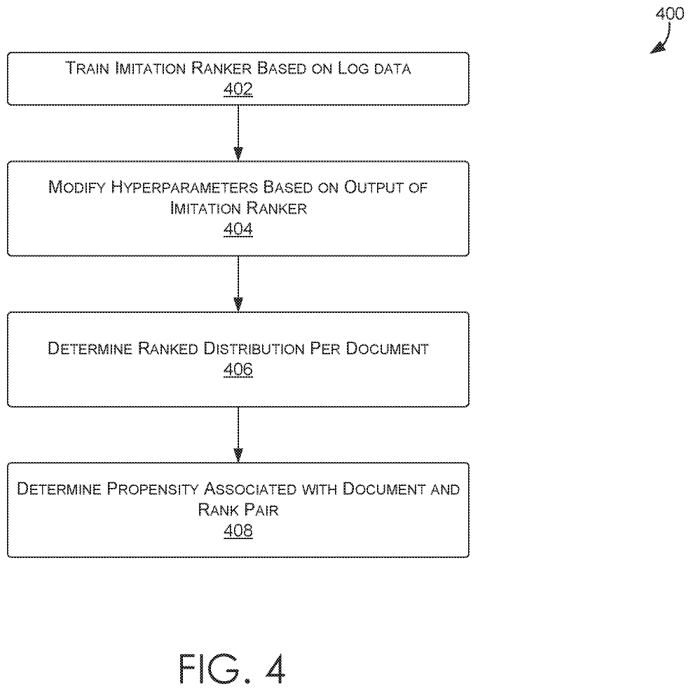

FIG. 4 is a flow diagram showing a method 400 for determining propensities associated with a document rank pair. The method 400 can be performed, for instance, by the offline evaluation system 104 of FIG. 1. Each block of the method 400 and any other methods described herein comprise a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 402, the system implementing the method 400 trains an imitation ranker based on log data. For example, a Subject Vector Machine (SVM) is trained using log data obtained from a recommendation system to approximate document and ranking pairs. In another example, an imitation ranker is trained using equation (5) using knowledge distillation as described above. In particular, the imitation ranker is trained to generate additional data similar to data generated by the recommendation system in order to increase an amount of data available to compute the rank distribution.

The system implementing the method 400 modifies one or more hyperparameters based on the output of the imitation ranker, as shown at block 404. For example, as described above the value, the value a in equation (7) is modified to increase the variance of the output of the imitation ranker. In addition, in various embodiments, additional or other hyperparameters can be used to modify the output of the imitation ranker.

At block 406, the system implementing the method 400 determines the ranked distribution per document. For example, the offline evaluation system uses the recursive algorithm in equation (8) and the scores from the imitation ranker and hyperparameter to compute the rank distribution. At block 408, the system implementing the method 400 determines the propensity associated with the document and rank pairs. As illustrated in FIG. 3, the rank distribution computed at step 406 is used in equation (4) to compute the propensities for the document and rank pairs. Furthermore, in an embodiment, this value is calculated for every impression generated by a new ranker for a particular query.

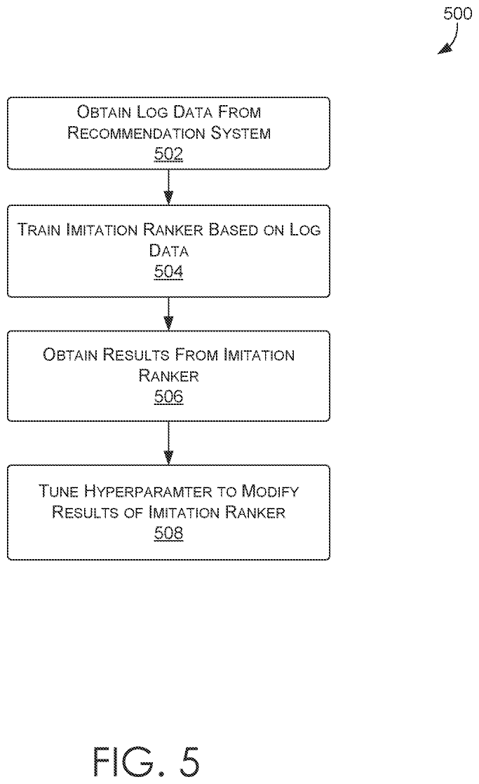

FIG. 5 is a flow diagram showing a method 500 for training an imitation ranker. The method 500 can be performed, for instance, by the offline evaluation system 104 of FIG. 1. As shown at block 502, the system implementing the method 500 obtains log data from a recommendation system. For example, a recommendation system executes a current ranker which processes queries and provides results in response to the queries. In an embodiment, the log data include queries, documents, ranks associated with the documents, and user interactions with the documents. For example, a particular entry in the log data includes a query executed by the current ranker, a ranked set of document returned by the current ranker, and data indicating documents interacted with by the user.

The system implementing the method 500 trains the imitation ranker based on the log data, as shown at block 504. For example, the offline evaluation system trains the imitation ranker based on equation (6) as described above. In various embodiments, different training methods such as deep learning are used in addition to or as an alternative to the training method described above. At block 506, the system implementing the method 500 obtains results from the imitation ranker. In an embodiment, the results include scores indicating a probability of a particular document being returned in response to a query at one or more ranks. For example, a document can have a 0.76 score for a first rank, a 0.74 score for a second rank, and a 0.43 score for a third rank.

At block 508, the system implementing the method 500 tunes a hyperparameter to modify the results of the imitation ranker. For example, as described above, the hyperparameter a in equation (7) is modified to increase the variance of the output of the imitation ranker. In various embodiments, the ranker from which the log data is obtained is deterministic, and to increase variance in the imitation ranker, one or more hyperparameters are used. In an embodiment, the value is modified based on an observation of the data generated by the imitation ranker. For example, an engineer or other entity can observe the data and tune the hyperparameter. In other embodiments, the hyperparameter is tuned using an algorithm. As described above, after completion of the method 500, the imitation ranker can be used by the offline evaluation system to measure the performance of a plurality of rankers without re-training.

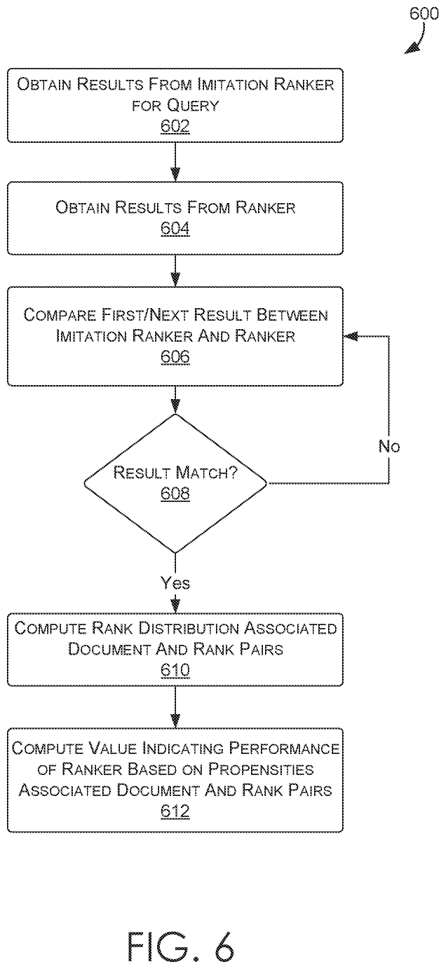

FIG. 6 is a flow diagram showing a method 600 for computing a value indicating the performance of a ranker (e.g., a new ranker and/or changes to an existing ranker). The method 600 can be performed, for instance, by the offline evaluation system 104 of FIG. 1. As shown at block 602, the system implementing the method 600 obtains results from an imitation ranker based on a query. For example, the imitation ranker can be trained using method 500 described above. Furthermore, in an embodiment, the imitation rank returns results that include scores associated with documents at a particular rank.

The system implementing the method 600 obtains results from a ranker, as shown at block 604. The results, in an embodiment, are obtained by causing the ranker to execute the same query provided to the imitation ranker on the same collection of documents. For example, the results obtained from the ranker include a ranked set of documents. Furthermore, in an embodiment, the ranker includes a new recommendation system. In other embodiments, the ranker includes modifications (e.g., new features, new parameters, etc.) to a ranker of an existing recommendation system.

At block 606, the system implementing the method 600 compares the first/next result obtained from the imitation ranker and the ranker. As described above, in various embodiments, the ranker is evaluated from impressions (e.g., document and rank pairs) that match between the imitation ranker and the ranker. For example, for every impression produced by the ranker being evaluated, the offline evaluation system computes the rank distribution and uses the rank distributions as the propensities for the document and rank pairs. At block 608, if the results match (e.g., imitation ranker and the ranker produce the same document with the same rank), the system implementing the method 600, continues to block 610 and computes the rank distribution associated with the document rank pair. However, if the results do not match, the system implementing the method 600 returns to block 606 and evaluates the next result.

Returning above, at block 610, the system implementing the method 600 computes the rank distribution associated with the document rank pair. For example, the scores from the imitation ranker are combined with the hyperparameters and the rank distribution is computed using equation (8). As described above, the rank distribution can then be used for the propensity associated with a particular document and rank pair. At block 612, the system implementing the method 600 computes a value indicating the performance of the ranker based on the propensity associated with a particular document and rank pair. For example, the propensity is used to compute the value in equation (4) which provides a metric based on various measures defined in equation (4) by m(cₖ, k). For example, the NoC or MRR can be used as metrics to quantify the performance of the ranker. Blocks 606 through 612 can be repeated for all impressions of the ranker to be evaluated.

### Exemplary Operating Environment

Having described embodiments of the present invention, FIG. 7 provides an example of a computing device in which embodiments of the present invention can be employed. Computing device 700 includes bus 710 that directly or indirectly couples the following devices: memory 712, one or more processors 714, one or more presentation components 716, input/output (I/O) ports 718, input/output components 720, and illustrative power supply 722. Bus 710 represents what can be one or more busses (such as an address bus, data bus, or combination thereof). Although the various blocks of FIG. 7 are shown with lines for the sake of clarity, in reality, delineating various components is not so clear, and metaphorically, the lines would more accurately be gray and fuzzy. For example, one can consider a presentation component such as a display device to be an I/O component. Also, processors have memory. The inventors recognize that such is the nature of the art and reiterate that the diagram of FIG. 7 is merely illustrative of an exemplary computing device that can be used in connection with one or more embodiments of the present technology. Distinction is not made between such categories as “workstation,” “server,” “laptop,” “handheld device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 700. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 712 includes computer storage media in the form of volatile and/or nonvolatile memory. As depicted, memory 712 includes instructions 724. Instructions 724, when executed by processor(s) 714 are configured to cause the computing device to perform any of the operations described herein, in reference to the above discussed figures, or to implement any program modules described herein. The memory can be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which can be built in. Illustrative components include a microphone, joystick, game pad, satellite dish, scanner, printer, wireless device, etc. I/O components 720 can provide a natural user interface (NUI) that processes air gestures, voice, or other physiological inputs generated by a user. In some instances, inputs can be transmitted to an appropriate network element for further processing. An NUI can implement any combination of speech recognition, touch and stylus recognition, facial recognition, biometric recognition, gesture recognition both on screen and adjacent to the screen, air gestures, head and eye tracking, and touch recognition associated with displays on computing device 700. Computing device 700 can be equipped with depth cameras, such as stereoscopic camera systems, infrared camera systems, RGB camera systems, and combinations of these, for gesture detection and recognition. Additionally, computing device 700 can be equipped with accelerometers or gyroscopes that enable detection of motion. The output of the accelerometers or gyroscopes can be provided to the display of computing device 700 to render immersive augmented reality or virtual reality.

Embodiments presented herein have been described in relation to particular embodiments which are intended in all respects to be illustrative rather than restrictive. Alternative embodiments will become apparent to those of ordinary skill in the art to which the present disclosure pertains without departing from its scope.

Various aspects of the illustrative embodiments have been described using terms commonly employed by those skilled in the art to convey the substance of their work to others skilled in the art. However, it will be apparent to those skilled in the art that alternate embodiments can be practiced with only some of the described aspects. For purposes of explanation, specific numbers, materials, and configurations are set forth in order to provide a thorough understanding of the illustrative embodiments. However, it will be apparent to one skilled in the art that alternate embodiments can be practiced without the specific details. In other instances, well-known features have been omitted or simplified in order not to obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules can be merged, broken into further sub-parts, and/or omitted.

The phrase “in one embodiment” or “in an embodiment” is used repeatedly. The phrase generally does not refer to the same embodiment; however, it can. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B and C” means “(A), (B), (C), (A and B), (A and C), (B and C) or (A, B and C).”

What is claimed is:

1. A computer-implemented method comprising:
obtaining, by an offline evaluation system, log data from a recommendation system including a new ranker, the log data indicating queries and ranked sets of documents generated at least in part by a current ranker of the recommendation system;
training, by the offline evaluation system, an imitation ranker using the log data;
cause the imitation ranker to generate a first result including a set of scores associated with document and rank pairs based on a query, the set of scores indicating a probability of a particular document being associated with a particular rank;
obtaining, from a new ranker, a second result including a ranked set of documents in response to the query;
determining, by the offline evaluation system, a rank distribution indicating propensities associated with the document and rank pairs for a set of impressions, where an impression of the set of impression includes a document and rank pair that is included in the first result and the second result; and
determining, by the offline evaluation system, a value associated with the new ranker.

2. The computer-implemented method of claim 1, wherein the recommendation system includes a search engine.

3. The computer-implemented method of claim 1, wherein the new ranker includes one or more modifications to the current ranker.

4. The computer-implemented method of claim 3, wherein the value includes a metric indicating a performance of the one or more modifications.

5. The computer-implemented method of claim 4, wherein the metric includes at least one of a relevance metric, an impression-level relevance metric, number of click, mean reciprocal rank, Kendall tau, expected reciprocal rank, mean average precision, precision at k, and normalize discounted cumulative gain.

6. The computer-implemented method of claim 1, wherein the computer-implemented method further comprises tuning the imitation ranker using one or more hyperparameters.

7. The computer-implemented method of claim 1, wherein the computer-implemented method further comprises determining a second value associated with a second ranker based at least in part on the imitation ranker without re-training the imitation ranker.

8. One or more computer storage media storing computer-useable instructions that, when used by a computing device, cause the computing device to perform operations, the operations comprising:
obtaining a ranked set of documents generated by an imitation ranker based on a query;
determining a hyperparameter associated with the imitation ranker to modify the ranked set of documents;
computing a rank distribution for documents included the ranked set of documents for a set of impressions generated by a new ranker of a recommendation system based on the query;
computing a set of document and rank propensities based on the rank distribution; and
determining a value indicating a performance of the new ranker of the recommendation system based on the set of document and rank propensities.

9. The one or more computer storage media of claim 8, wherein the recommendation system includes a current ranker that generates log data used to train the imitation ranker.

10. The one or more computer storage media of claim 9, wherein the new ranker includes a set of changes to the current ranker and the new ranker generates the set of impressions.

11. The one or more computer storage media of claim 10, wherein the set of changes includes at least one of: a new ranking feature, a modification to a ranking model, a modification to a parameter of the current ranker, and a modification to a hyperparameter of the current ranker.

12. The one or more computer storage media of claim 8, wherein the operations further comprise training the imitation ranker using log data obtained from a second recommendation system.

13. The one or more computer storage media of claim 12, wherein the log data includes an indication of at least a ranked set of documents and a user interaction with a document of the ranked set of document generated in response to the query.

14. The one or more computer storage media of claim 8, wherein determining the value further comprises determining a Number of Clicks metric based on the set of document and rank propensities.

15. The one or more computer storage media of claim 8, wherein determining the value further comprises determining a Mean Reciprocal Rank metric based on the set of document and rank propensities.

16. A computer system comprising:
a processor; and
a computer storage medium storing computer-useable instructions that, when used by the processor, causes the computer system to perform operations comprising:
generating, by an imitating ranker, a set of document and rank pairs based on a query;
determining, by an offline evaluation system, a set of document and rank propensities based on a rank distribution computed for a set of impressions generated by a ranker based on the query, the set of impression including documents included in the set of document and rank pairs; and
determining, by the offline evaluation system, a metric indicating a performance of the ranker based on the set of document and rank propensities..

17. The computing system of claim 16, wherein generating the set of documents further comprise tuning the imitating ranker using a hyperparameter.

18. The computing system of claim 17, wherein a value of the hyperparameter is determined based at least in part on the set of document and rank pairs.

19. The computing system of claim 16, wherein the set of document and rank pairs includes a score for a document at a rank in a ranked set of documents.

20. The computing system of claim 16, wherein the metric includes at least one of: a relevance metric, an impression-level relevance metric, number of click, mean reciprocal rank, Kendall tau, expected reciprocal rank, mean average precision, precision at k, and normalize discounted cumulative gain.
